(19) United States
(12) Patent Application Publication
(10) Pub. No.: US 2026/0156429 A1
(43) Pub. Date: Jun. 4, 2026

(54) METHOD AND SYSTEM FOR AUTOMATIC AUDIO CALIBRATION

(71) Applicant: HARMAN INTERNATIONAL INDUSTRIES, INCORPORATED, Stamford, CT (US)

(72) Inventors: Pingzhan LUO, Nanshan Shenzhen, Guangdong (CN); Guochao LU, Nanshan Shenzhen, Guangdong (CN); Jianwen ZHENG, Nanshan Shenzhen, Guangdong (CN)

(73) Assignee: HARMAN INTERNATIONAL INDUSTRIES, INCORPORATED, Stamford, CT (US)

(21) Appl. No.: 19/124,139

(22) PCT Filed: Dec. 2, 2022
(86) PCT No.: PCT/CN2022/136218

§ 371 Date: Apr. 24, 2025

(51) Int. Cl. H04S 7/00

(52) U.S. Cl. CPC H04S 7/301; H04S 7/303; H04S 7/307

(57) ABSTRACT

A method and system of automatic audio calibration for an audio system in a room. The method uses a camera to capture videos of the room. The method further uses a processor to retrieve environment information and listener information from the videos; estimate environment influence in a sound field at the listener based on the environment information and the listener information; and generate a compensating filter for the audio system to compensate for the estimated environment influence.

### CROSS-REFERENCE TO RELATED APPLICATION

This application is the U.S. national phase of PCT Application No. PCT/CN2022/136218 filed on Dec. 2, 2022 the disclosure of which is hereby incorporated in its entirety by reference herein.

### TECHNICAL FIELD

The present disclosure relates to audio processing, in particular, to a method and system for automatic audio calibration.

### BACKGROUND

Usually, sound field produced by a speaker is not only decided by the speaker itself, but also greatly influenced by the environment. There will inevitably be many obstacles or reflectors in the room, such as walls, floors, tables, desks, etc. When the sound waves reach the obstacles or reflectors, there comes reflection, scattering and diffraction. The reflected waves often interfere with the primary sound, which leads to an increase or a decrease of the frequency response in different frequency bands. This is particularly obvious when distances are small, which indicates that the user is listening to the speaker in the near field with large reflectors nearby. A typical case for home audio is that a speaker is on a desk while a listener is sitting in front of it. The listener can feel the timbre of the sound changes drastically while leaning forward and back.

Calibration is usually applied to compensate for environment influence in home audio products, so that users can hear similar sounds in their rooms although the room environments may be different. Currently, calibration is mainly realized by acoustic methods. Built-in or external microphones are used to measure the sound field so that the speaker's output can be modified according to the measured results. However, built-in microphones can only measure the sound near the speaker, so only a rough estimate of the sound field at the listener can be obtained without accurate information. Besides, the calibration by built-in microphones cannot adapt to the user who is moving. On the contrary, using external microphones in the listening area is another effective calibration method. It can directly measure the sound field at the user's position but is often complained about its inconvenience to use.

Therefore, other improved calibration methods need to be developed to tune the sound performance.

### SUMMARY

According to one aspect of the disclosure, a method of automatic audio calibration for an audio system in a room is provided. The method may use a camera to capture videos of the room through a camera. The method may further retrieve environment information and listener information from the videos; estimate environment influence in a sound field at the listener based on the environment information and the listener information; and generate a compensating filter for the audio system to compensate for the estimated environment influence.

According to another aspect of the present disclosure, a system of automatic audio calibration for an audio system is provided. The system may comprise a camera and a processor. The camera may be configured to capture videos of the room through a camera. The processor may be coupled to the camera and may be configured to retrieve environment information and listener information from the videos. The processor may further be configured to estimate environment influence in a sound field at the listener based on the environment information and the listener information, and generate a compensating filter for the audio system to compensate for the estimated environment influence.

According to yet another aspect of the present disclosure, a non-transitory computer-readable storage medium comprising computer-executable instructions is provided which, when executed by a computer, causes the computer to perform the method disclosed herein.

### BRIEF DESCRIPTION OF THE DRAWINGS

FIG. 1 illustrates a schematic diagram of an audio system according to one or more embodiments of the present disclosure;

FIG. 2 illustrates a flowchart of an automatic audio calibration method for an audio system according to one or more embodiments of the present disclosure.

FIG. 3 illustrates a schematic diagram for the information retrieval from the video according to one or more embodiments of the present disclosure;

FIG. 4 illustrates an example of video captured by the TOF camera according to one or more embodiments of the present disclosure;

FIG. 5 illustrates a simple configuration for the audio calibration process; and

FIG. 6 illustrates an example of magnitude responses of the direct sound, total sound, and the compensating EQ filter.

It is contemplated that elements disclosed in one embodiment may be beneficially utilized in other embodiments without specific recitation. The drawings referred to here should not be understood as being drawn to scale unless specifically noted. Also, the drawings are often simplified and details or components omitted for clarity of presentation and explanation. The drawings and discussion serve to explain principles discussed below, where like designations denote like elements.

### DETAILED DESCRIPTION OF THE PREFERRED EMBODIMENTS

Examples will be provided below for illustration. The descriptions of the various examples will be presented for purposes of illustration, but are not intended to be exhaustive or limited to the embodiments disclosed. Many modifications and variations will be apparent to those of ordinary skill in the art without departing from the scope and spirit of the described embodiments.

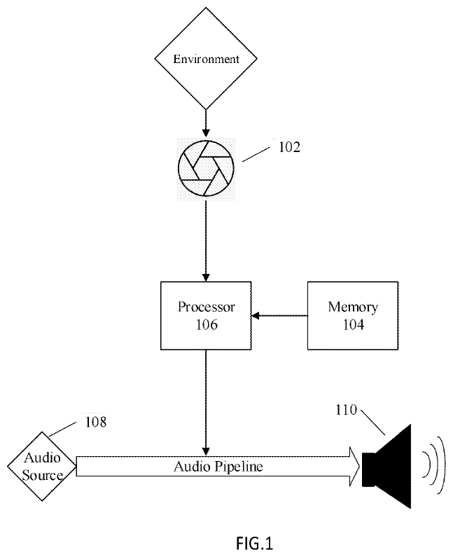

In this disclosure, an improved method and system for automatic audio calibration are provided. The method and system proposed in this disclosure combine an audio system with at least one camera to provide the listener with consistent and stable sound timbre regardless of the listener's movement and different room environments. The use of a camera can provide a complete view of the room environment and keep continuous head-tracking for the moving listener without any external equipment. In particular, the camera may be used to detect the room by recording a video about the room. From the video, the method and system may retrieve useful information for calibration, such as information about the room environment and information about the listener's location. Thus, the method and system may estimate the environment influence on the sound field generated at the listener based on the useful information and adaptively adjust the audio system to compensate for the environment influence so that a stable timbre can be provided to the listener, regardless of the room environment and the listener's movement. By combining the audio system with the camera and estimating and compensating for the environment influence based on video detection, the proposed approach can realize automatic audio calibration without complicated installation and operation, which may provide a user with a better listening experience and may greatly improve the user's product experience. The approach will be explained in detail with reference to FIGS. 1-6 as follows.

FIG. 1 illustrates a schematic diagram of an audio system according to one or more embodiments of the present disclosure. The system 100 shown in FIG. 1 includes a camera 102, a memory 104, a processor 106, an audio source 108 and a speaker 110.

The camera 102 may be positioned in any location near the speaker 110. For example, the camera 102 can be positioned on a top or a front of a speaker box including the speaker 110, or any position near the speaker where the camera can detect and record the information of the room. The camera 102 may be an optical camera such as an red, green, and blue (RGB) camera, or a depth camera such as a Time of Flight (TOF) camera, having one or more view angles. In some examples, the camera 102 may be a digital camera configured to acquire the video with a series of frames (e.g., images) at a programmable frame rate. In some examples, the frame rate may be selected based on a processing speed of the processor 106.

The memory 104 may include any non-transitory tangible computer readable medium in which programming instructions are stored. As used herein, the term “tangible computer readable medium” is expressly defined to include any type of computer readable storage. The example methods described herein may be implemented using coded instruction (e.g., computer readable instructions) stored on a non-transitory computer readable medium such as a flash memory, a read-only memory (ROM), a random-access memory (RAM), a cache, or any other storage media in which information is stored for any duration (e.g. for extended time periods, permanently, brief instances, for temporarily buffering, and/or for caching of the information). Computer memory of computer readable storage mediums as referenced herein may include volatile and non-volatile or removable and non-removable media for a storage of electronically formatted information, such as computer readable program instructions or modules of computer readable program instructions, data, etc., that may be stand-alone or as part of a computing device. Examples of computer memory may include any other medium which can be used to store the desired electronic format of information and which can be accessed by the processor or processors or at least a portion of a computing device.

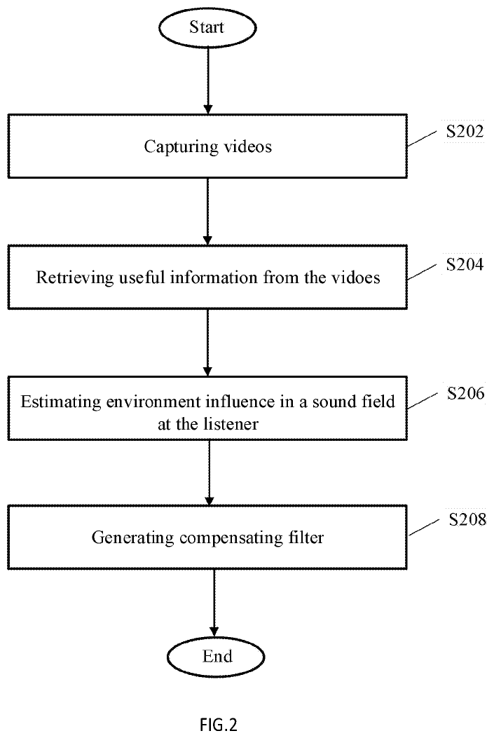

The processor 106 may be configured to execute machine readable instructions stored in the memory 104. The processor 106 may be electronically and/or communicatively coupled to the camera 102, and may process and analyze the video including images received from the camera 102. In some examples, the processor 106 may be configured to retrieve useful information from the video, estimate environment influence based on the retrieved information, and generate a calibration/compensating filter with adaptive filter coefficients to compensate for the environment influence. The processor 106 may perform the above calibration methods, as will be elaborated hereafter with respect to FIGS. 2-6.

The processor 106 may be single core or multi-core, and the programs executed by processor 106 may be configured for parallel or distributed processing. The processor 106 may be any technically feasible hardware unit configured to carry out processing functions and execute software applications, including without limitation, a central processing unit (CPU), a microcontroller unit (MCU), an application specific integrated circuit (ASIC), a digital signal processor (DSP) chip, a field-programmable gate array (FPGA), a graphic board, and so forth.

Moreover, FIG. 1 shows an audio pipeline from the audio source 108 to the speaker 110. It can be understood that some modules/functions (not shown) in the audio pipeline may include EQ filter(s) (equalizer filter(s)), limiter, gain unit, delay unit, amplifier, and so on, which may be implemented by software, hardware or a combination thereof. It can also be understood that the audio system may include more than one speaker and more than one corresponding camera for the more than one speaker. FIG. 1 is only one example for clearly presenting and explaining the principle of the proposed method and system, which will be elaborated hereafter.

FIG. 2 illustrates a flowchart of the method of automatic audio calibration for an audio system according to one or more embodiments of the present disclosure. At S202, videos of the room where the audio system is located may be obtained through a camera. At S204, useful information may be retrieved from the videos. In some embodiments, the useful information may include environment information and listener information in the room. In some examples, the environment information includes location information about at least one reflector or obstacle in the room. In some embodiments, the listener information includes location information about a listener in the room, such as a head location or ear location of the listener. Then, at S206, based on the retrieved environment information and listener information, the environment influence in a sound field at the listener (e.g., at the listener's head or ears) may be estimated. The environment influence is associated with at least one reflecting sound caused by the at least one reflector or obstacle. At S208, based on the estimated environment influence, a compensating filter may be generated. In some examples, filter coefficients for the compensating filter may be generated and applied to the EQ filters in the audio system.

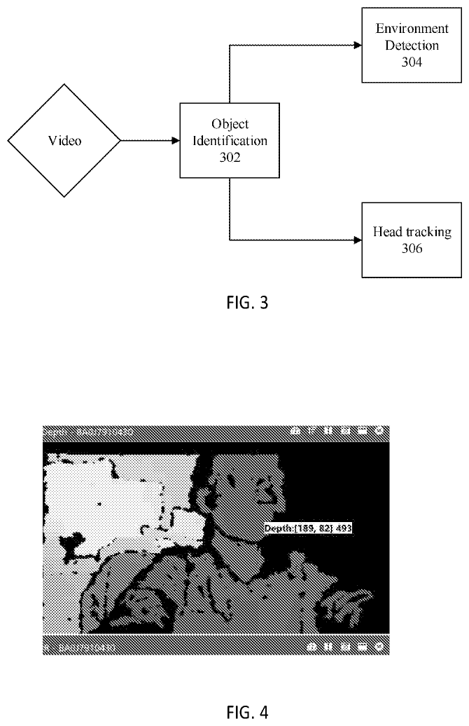

FIG. 3 illustrates a schematic diagram of the information retrieval from the video by the processor according to one or more embodiments of the present disclosure. At block 302, different objects may be roughly identified in the video, using the existing object identification methods or algorithms. Among the identified objects, the listener and large reflectors should be picked out, while small reflectors can be neglected. In some examples, some large reflectors may be determined as main reflectors by comparing the size of each reflector to a size threshold. The size threshold may be preset by engineers according to their practice experience. In some examples, the reflector with a size larger than the size threshold is selected as the main reflector. For example, main reflectors may involve walls, floors, and furniture with large planes such as tables and desks.

At block 304, environment detection may be performed to obtain the location information of the identified main reflectors. In some examples, the environment detection may be performed only once, for example, when the audio system is first powered on. In some examples, the environment detection may be performed at a long time interval, such as one month or several months, or one year. This is because these large reflectors are seldom moved. Once the location information is obtained, other information can also be inferred, such as the room volume and shape.

At block 306, listener detection may be performed to obtain the location information of the listener. In some examples, the listener detection may be performed using the existing head tracking method or algorithm to obtain the location information of the listener's head. In contrast to the environment detection, the detection of the listener should always be running to track the movement of the listener. Knowledge of the real-time location of listener's head or ears is necessary for the calibration to be effective.

The specific method or algorithm used for information retrieval may be varied according to the exact types of cameras and videos. When considering a person's location tracking, a usual approach is to use optical camera, such as RGB camera, combined with face recognition. However, the optical camera suffers from environment conditions (shadow, low-light, sunlight, etc.) and cannot get accurate measurement of the distance. Besides, complex processing (such as face recognition algorithms) is needed. More importantly, there are also privacy concerns with the cameras.

In the present disclosure, a recommended example is to use the TOF camera. The TOF camera provides 3-D images by a Complimentary Metal Oxide Semiconductor (CMOS)/CCLD array together with an active modulated light source. The TOF camera works by illuminating the scene with a modulated light source (solid-state laser or light emitter diode (LED), usually near-infra light invisible to human eyes) and observing the reflected light. The time delay of the light can reflect the distance information.

FIG. 4 illustrates an example of video captured by the TOF camera. Although the video example in FIG. 4 is displayed herein as a grayscale image, it can be understood that the video captured by the TOF camera may be in color. Different colors are used to distinguish objects in different depths. For example, the listener can be recognized with red sketches, and other reflectors as yellow or green blocks. Even in the grayscale image, the listener and the reflectors can also be recognized with different gray levels. The coordinates shown in FIG. 4 as an example indicates the location and can be directly available by TOF camera. Thus, the processor may obtain location information of the listener and the main reflectors from the videos received by the camera.

The TOF camera used in this disclosure has the advantages of robustness in various environments (particularly dark environments), easy integration with the audio system due to comparatively simple and on-chip processing for target identification and tracking, and no privacy concerns. For example, a fairly simple algorithm can be applied to detect the listener and large reflectors in the background. As shown in FIG. 4, different targets can be comparatively easily distinguished by the depth information, whereas the normal RGB camera may require complicated algorithms for face recognition. The TOF camera may keep continuous tracking of the listener (e.g., listener's head or ears) and provide the video including the location information associated with the listener's movement to the processor.

Once the processor retrieves the location information associated with the reflectors and the listener from the video, the processor may analyze the location information to estimate environment influence to the sound field at the listener, and may derive filter coefficients of the compensating filter (i.e., EQ filter coefficients adapted to EQ filters in the audio system) to compensate for the estimated environment influence. For example, the EQ filters in the audio system may include high-pass filters, low-pass filters, bandpass filter, peak filters, and so on. In some embodiments, the environment influence is associated with at least one reflecting sound caused by at least one reflector. In some embodiments, the compensating filter (e.g., compensating EQ filter) can be generated or designed by empirical approaches and by physical modelling and calculations.

An example of obtaining the compensating filter by modelling and calculation methods will be illustrated. For illustration, a simple set up of calibration process is shown in FIG. 5. FIG. 5 illustrates a spatial location of the speaker. As shown in FIG. 5, a speaker box 502 having a speaker inside is positioned on a table with a large reflection plane. A camera 504 (e.g., TOF camera) is positioned near the speaker and on the top of the speaker box. It can be understood that the example of FIG. 5 is just presented for purposes of illustration but are not intended to be exhaustive or limited to the examples disclosed herein. The camera 504 may be located at any position near the speaker where the camera can detect and record the information of the room.

FIG. 5 illustrates a sound propagation path 508 for propagating a direct sound from speaker to the listener 506. The direct sound refers to the sound received by the listener, which is emitted from the speaker and directly reaches the listener without any reflection. There is another sound propagation path 510 for propagating a reflecting sound. The reflecting sound refers to the sound that reaches the listener after the sound emitted by the speaker is reflected by the reflection plane.

In some embodiments, the retrieved location information may include the distance L, which indicates the distance from the speaker to the listener's head or ears. In some embodiments, the retrieved location information may further include a distance H, which indicates the vertical distance from the listener's head or ears to a plane where a reflection plane is located. In some embodiments, the retrieved location information may include a distance h which indicates a vertical distance from the speaker to the reflection plane of a plane where the speaker is located. In the example of FIG. 5, the listener is L away from the speaker, the height of the listener's head or ears above the reflection plane of the table is H, and the height of the driver of the speaker above the table plane is h. The locations of L, H and h can all obtained from the retrieved useful information. Alternatively, the height h may be obtained from the design of the layout of the speaker.

Based on the location information L, H and h, the processor may estimate the environment influence on the sound field at the listener. In some embodiments, sound pressure is used as a kind of parameter to estimate the environment influence. For convenience, it is supposed that the damping factor in the sound propagation and reflection is uniform. The total sound pressure Pₜ is a superposition of a direct sound pressure P_{d} and a reflecting sound pressure Pᵣ, which is written as the following:

$${P}_{t} = {P}_{d} + {P}_{r} \approx {P}_{0} {e}^{- jkL} + β {P}_{0} {e}^{- jk \sqrt{{L}^{2} + 4 {h}^{2} + 4 hL sin θ}} , \qquad ( 1 )$$

where P₀ is the sound pressure at the speaker, k is the wave number of the sound, and β is the damping factor. The approximation holds when L>>h. The traveling distance of the reflecting sound can be obtained by the Cosine Theorem. The angle θ is obtained based on the location of the speaker and the listener as the following:

$$sin θ = \frac{H - h}{L} . \qquad ( 2 )$$

Thus, the total sound pressure at the listener is expressed as

$${P}_{t} = {P}_{0} {e}^{- jkL} + β {P}_{0} {e}^{- jk \sqrt{{L}^{2} + 8 {h}^{2} + 4 Hh}} , \qquad ( 3 )$$

It can be understood that the reflecting sound pressure Pᵣ represents the interference caused by the reflecting sound, which could be considered as the environment influence and can be estimated based on the above equations. Due to the interference caused by the reflecting sound, the total sound heard by the listener is different from the direct sound, and the response of the total sound varies with frequencies. Therefore, the influence of the room environment (e.g., caused by some main reflectors) on the sound field at the listener needs to be compensated or eliminated.

In some embodiments, the compensating filter can be generated or designed to compensate for the interference caused by the reflecting sound. In some examples, based on the total sound pressure and the reflecting sound pressure, the compensating filter can be generated or designed to compensate for the reflecting sound interference. In some embodiments, filter coefficients for the compensating filter may be generated based on the estimated environment influence calculated by the above equations. The generated filter coefficients may be applied to the EQ filters in the audio system. EQ filters applied with the generated filter coefficients may collectively correspond to the compensating filter. In some embodiments, the generation of filter coefficients for the EQ filters in the audio system may comprise generating filter coefficients so that the response of the EQ filters applied with the generated filter coefficients (i.e., the response of the compensating filter) can compensate for or eliminate the difference between a frequency response of the total sound and a frequency response of direct sound. In some examples, the generation of filter coefficients for the EQ filter in the audio system may comprise generating filter coefficients so that the magnitude response of the compensating filter can compensate for or eliminate the difference between the magnitude response of the total sound and the magnitude response of direct sound. In other words, some adaptive EQ filters may be chosen to compensate for the environment influence so that a comparatively flat frequency response is achieved at the listener.

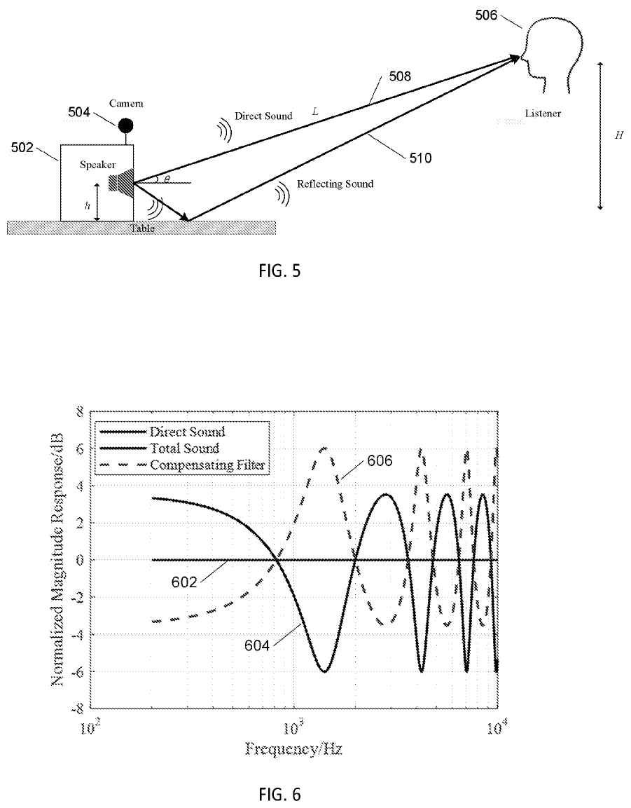

FIG. 6 illustrates an example of frequency response curves of the direct sound, total sound and the compensating EQ filter. In FIG. 6, three curves 602, 604 and 606 indicative of the magnitudes of the direct sound response, total sound response and compensating filter response, respectively, which are simulated with the following parameters: h=0.08 cm, H=0.48 cm, L=0.79 cm, β=0.5. For a more intuitive illustration, the magnitude responses shown in FIG. 6 are normalized magnitude responses. For example, the normalized magnitude responses of the direct sound and the total sound are obtained by

$$\vert \frac{{P}_{d}}{{P}_{0}} \vert and \vert \frac{{P}_{t}}{{P}_{0}} \vert ,$$

respectively. It can be seen that the total sound field at the listener varies with frequencies due to interference from reflecting sound waves. The interference from reflecting sound waves leads to an increase or a decrease of the frequency response in different frequency bands, depending on the locations of the listener the speaker, and the reflectors. However, the generated compensating filter can compensate for the environment influence. In addition, the generated compensating filter can compensate for the listener's movement, since the listener's location is continuously tracked. The filter coefficients of the EQ filters in the audio system may be adjusted in real-time according to the detected location of the listener's head or ears, as described above.

For clarity of presentation and explanation, a configuration with one camera and one speaker is taken as an example to illustrate how to retrieve and analyze information from the video and how to estimate and compensate for the environment influence on the sound field at the listener. However, it can be understood that the audio system may include a plurality of speakers, and there may be a corresponding camera near each speaker. For each configuration including one speaker and one camera, the method described in this disclosure can be adopted. In addition, it can be understood that there may be multiple reflectors in the room, and thus multiple reflecting sounds are generated by these multiple reflectors. FIG. 5 shows only one reflecting sound that is presented for purposes of illustration, but are not intended to be exhaustive or limited to the amounts of the reflecting sounds. In the case of multiple reflecting sounds, the sound pressure of the reflecting sound Pᵣ can represent the superposition of the sound pressures of each reflecting sound, for example, Pᵣ=Pᵣ₁+Pᵣ₂ . . . , +Pᵣₙ. For each reflecting sound, the method described in this disclosure can be used to estimate the interference of the reflecting sound to the sound field, and generate appropriate filter coefficients to compensate for or counteract the interference caused each the reflecting sound.

In this disclosure, a new acoustic calibration method by video is provided. The environment and the listener in the room may be captured in the video. Thus, the location information of the environment and location information of the listener may be retrieved, and the listener's location may be continuously tracked. Then, the interference from reflecting sound waves at the listener can be predicted based on the location information to generate EQ filters to compensate for the environment influence. By using the technology described herein, an all-in-one form factor combining speaker and camera can be obtained. The automatic audio calibration described herein can compensate for the influence of the room environment and the listener's location. Furthermore, no additional hardware is required, and there are no privacy concerns. In addition, no complex algorithm are needed, and accordingly the computing time is saved and the system robustness is increased. Thus, the listeners can have a better listening experience.

Clause 1. In some embodiments, a method of automatic audio calibration for an audio system in a room, comprising: capturing videos of the room through a camera; retrieving environment information and listener information from the videos; estimating environment influence in a sound field at the listener based on the environment information and the listener information; and generating a compensating filter for the audio system to compensate for the estimated environment influence.

Clause 2. The method according to clause 1, wherein the retrieving the environment information and listener information from the videos comprises: identifying objects from the videos; picking out at least one main reflector and a listener; and obtaining the location information of the at least one main reflector and the location information of the listener.

Clause 3. The method according to any one of clauses 1-2, wherein the estimating the environment influence in the sound field at the listener comprises estimating at least one reflecting sound pressure of at least one reflecting sound based on the environment information and the listener information, wherein the at least one reflecting sound is caused by at least one reflection plane of the at least one main reflector.

Clause 4. The method according to any one of clauses 1-3, wherein the generating the compensating filter for the audio system comprises generating filter coefficients based on the estimated environment influence.

Clause 5. The method according to any one of clauses 1-4, further comprises applying the generated filter coefficients to EQ filters in the audio system.

Clause 6. The method according to any one of clauses 1-5, 6, wherein the estimating at least one reflecting sound pressure comprises: obtaining a first distance indicative of a distance from a speaker in the audio system to the listener's head or ears; and for each reflector, obtaining a second distance indicative of a vertical distance from the listener's head or ears to a plane where the reflection plane of the reflector is located; obtaining a third distance indicative of a vertical distance from the speaker to the reflection plane; and estimating the reflecting sound pressure based on the first distance, the second distance and the third distance.

Clause 7. The method according to any one of clauses 1-6, wherein the generating the filter coefficients based on the estimated environment influence comprises generating the filter coefficients so that a magnitude response of the compensating filter with the generated filter coefficients compensates for a difference between a magnitude response of a total sound and a magnitude response of a direct sound.

Clause 8. The method according to any one of clauses 1-7, wherein the total sound includes a superposition of the direct sound and at least one reflecting sound, the direct sound indicates a sound wave emitted from the speaker and directly reaching the listener without any reflection.

Clause 9. The method according to any one of clauses 1-8, wherein the picking out at least one main reflector comprises selecting at least one reflector whose size is larger than a size threshold as the at least one main reflector.

Clause 10. The method according to any one of clauses 1-9, wherein the environment information includes location information of at least one main reflector, wherein the listener information includes location information of the listener's head or ears.

Clause 11. In some embodiments, a system of automatic audio calibration for an audio system in a room, comprising: a camera, configured to capture videos of the room through a camera; and a processor coupled to the camera and configured to: retrieve environment information and listener information from the videos; estimate environment influence in a sound field at the listener based on the environment information and the listener information; and generate a compensating filter for the audio system to compensate for the estimated environment influence.

Clause 12. The system according to clause 11, wherein the processor is further configured to: identify objects from the videos; pick out at least one main reflector and a listener; and obtain the location information of the at least one main reflector and the location information of the listener.

Clause 13. The system according to any one of clauses 11-12, wherein the processor is further configured to estimate at least one reflecting sound pressure of at least one reflecting sound based on the environment information and the listener information, wherein the at least one reflecting sound is caused by at least one reflection plane of the at least one main reflector.

Clause 14. The system according to any one of clauses 11-13, wherein the processor is further configured to generate filter coefficients based on the estimated environment influence.

Clause 15. The system according to any one of clauses 11-14, wherein the processor is further configured to apply the generated filter coefficients to EQ filters in the audio system.

Clause 16. The system according to any one of clauses 11-15, 16. wherein the processor is further configured to: obtain a first distance indicative of a distance from a speaker in the audio system to the listener's head or ears; and for each reflector, obtain a second distance indicative of a vertical distance from the listener's head or ears to a plane where the reflection plane of the reflector is located; obtain a third distance indicative of a vertical distance from the speaker to the reflection plane; and estimate the reflecting sound pressure based on the first distance, the second distance and the third distance.

Clause 17. The system according to any one of clauses 11-16, wherein the processor is further configured to generate the filter coefficients so that a magnitude response of the compensating filter with the generated filter coefficients compensates for a difference between a magnitude response of a total sound and a magnitude response of a direct sound.

Clause 18. The system according to any one of clauses 11-17, wherein the total sound includes a superposition of the direct sound and at least one reflecting sound, the direct sound indicates a sound wave emitted from the speaker and directly reaching the listener without any reflection.

Clause 19. The system according to any one of clauses 11-18, wherein the processor is further configured to select at least one reflector whose size is larger than a size threshold as the at least one main reflector.

Clause 20. In some embodiments, a computer-readable storage medium comprising computer-executable instructions which, when executed by a computer, causes the computer to perform the method according to any one of claims 1-10.

The descriptions of the various embodiments have been presented for purposes of illustration, but are not intended to be exhaustive or limited to the embodiments disclosed. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to specific described embodiments. Instead, any combination of the preceding features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the preceding aspects, features, embodiments and advantages are merely illustrative and are not considered elements or limitations of the appended claims except where explicitly recited in a claim(s).

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module”, “unit” or “system.”

The present disclosure may be a system, a method, and/or a computer program product. The computer program product may include a computer readable storage medium (or media) having computer readable program instructions thereon for causing a processor to carry out aspects of the present disclosure.

Computer readable program instructions described herein can be downloaded to respective calculating/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

The flowchart and block diagrams in the drawings illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

1. A method of automatic audio calibration for an audio system, comprising:
capturing videos of a room through a camera;
retrieving environment information and listener information from the videos;
estimating environment influence in a sound field at a listener based on the environment information and the listener information; and
generating a compensating filter for the audio system to compensate for the estimated environment influence.

2. The method according to claim 1, wherein the retrieving the environment information and the listener information from the videos comprises:
identifying objects from the videos;
picking out at least one main reflector and the listener; and
obtaining location information of the at least one main reflector and the location information of the listener.

3. The method according to claim 2, wherein the estimating the environment influence in the sound field at the listener comprises estimating at least one reflecting sound pressure of at least one reflecting sound based on the environment information and the listener information, wherein the at least one reflecting sound is caused by at least one reflection plane of the at least one main reflector.

4. The method according to claim 1, wherein the generating the compensating filter for the audio system comprises generating filter coefficients based on the estimated environment influence.

5. The method according to claim 4, further comprises applying the generated filter coefficients to EQ filters in the audio system.

6. The method according to claim 3, wherein the estimating the at least one reflecting sound pressure comprises:
obtaining a first distance indicative of a distance from a speaker in the audio system to a head or ears of the listener; and
for each reflector:
obtaining a second distance indicative of a vertical distance from the head or ears of the listener to a plane where the reflection plane of the reflector is located;
obtaining a third distance indicative of a vertical distance from the speaker to the reflection plane; and
estimating the reflecting sound pressure based on the first distance, the second distance and the third distance.

7. The method according to claim 4, wherein the generating the filter coefficients based on the estimated environment influence comprises generating the filter coefficients so that a magnitude response of the compensating filter with the generated filter coefficients compensates for a difference between a magnitude response of a total sound and a magnitude response of a direct sound.

8. The method according to claim 7, wherein the total sound includes a superposition of the direct sound and at least one reflecting sound, the direct sound indicates a sound wave emitted from a speaker and directly reaching the listener without any reflection.

9. The method according to claim 2, wherein the picking out at least one main reflector comprises selecting at least one reflector whose size is larger than a size threshold as the at least one main reflector.

10. The method according to claim 1, wherein the environment information includes location information of at least one main reflector, wherein the listener information includes location information of a head or ears of the listener.

11. A system of automatic audio calibration for an audio system, comprising:
a camera, configured to capture videos of a room; and
a processor coupled to the camera and configured to:
retrieve environment information and listener information from the videos;
estimate environment influence in a sound field at a listener based on the environment information and the listener information; and
generate a compensating filter for the audio system to compensate for the estimated environment influence.

12. The system of claim 11, wherein the processor is further configured to:
identify objects from the videos;
pick out at least one main reflector and a listener; and
obtain location information of the at least one main reflector and location information of the listener.

13. The system of claim 12, wherein the processor is further configured to estimate at least one reflecting sound pressure of at least one reflecting sound based on the environment information and the listener information, wherein the at least one reflecting sound is caused by at least one reflection plane of the at least one main reflector.

14. The system of claim 11, wherein the processor is further configured to generate filter coefficients based on the estimated environment influence.

15. The system of claim 14, wherein the processor is further configured to apply the generated filter coefficients to EQ filters in the audio system.

16. The system of claim 13, wherein the processor is further configured to:
obtain a first distance indicative of a distance from a speaker in the audio system to a head or ears of the listener; and
for each reflector:
obtain a second distance indicative of a vertical distance from the head or ears of the listener to a plane where the reflection plane of the reflector is located;
obtain a third distance indicative of a vertical distance from the speaker to the reflection plane; and
estimate the reflecting sound pressure based on the first distance, the second distance and the third distance.

17. The system of claim 14, wherein the processor is further configured to generate the filter coefficients so that a magnitude response of the compensating filter with the generated filter coefficients compensates for a difference between a magnitude response of a total sound and a magnitude response of a direct sound.

18. The system of claim 17, wherein the total sound includes a superposition of the direct sound and at least one reflecting sound, the direct sound indicates a sound wave emitted from a speaker and directly reaching the listener without any reflection.

19. The system of claim 12, wherein the processor is further configured to select at least one reflector whose size is larger than a size threshold as the at least one main reflector.

20. A non-transitory computer-readable storage medium comprising computer-executable instructions which, when executed by a computer, causes the computer to:
receive captured videos of a room;
retrieve environment information and listener information from the videos;
estimate environment influence in a sound field at a listener based on the environment information and the listener information; and
generate a compensating filter for an audio system to compensate for the estimated environment influence.
